(19) United States
(12) Patent Application Publication
(10) Pub. No.: US 2006/0143019 A1
(43) Pub. Date: Jun. 29, 2006

(54) Digital audio device and audio data output method

(76) Inventors: Seigo Suguta, Osaka (JP); Ryoji Suzuki, Nara (JP)

Correspondence Address: MCDERMOTT WILL & EMERY LLP, 600 13TH STREET, N.W., WASHINGTON, DC, 20005-3096, US

(21) Appl. No.: 10/534,122

(22) PCT Filed: Jul. 26, 2004
(86) PCT No.: PCT/JP04/10995

§ 371 Date: May 6, 2005

(30) Foreign Application Priority Data
Aug. 19, 2003 (JP) 2003-295304

(51) Int. Cl. G10L 21/00

(52) U.S. Cl. 704/500

(57) ABSTRACT

A digital audio device for outputting information recorded on a recording medium such as a DVD as audio data in compliance with a predetermined standard, wherein the digital audio device produces such audio data that a device connected to the digital audio device can identify audio track boundaries. A digital audio device (10A) includes: a track boundary detection section (14) for detecting an audio track boundary based on information read out from a recording medium (20); a track boundary data production section (15) for producing a track boundary data indicating the detected audio track boundary; and an auxiliary information production section (16) for producing auxiliary information by adding a control code in compliance with a predetermined standard to the produced track boundary data. An audio data reproduction section (13A) outputs audio data reproduced from the recording medium (20) with the auxiliary information being superimposed thereon.

### TECHNICAL FIELD

The present invention relates to a digital audio device for outputting digital audio data and a method for outputting audio data, and more particularly to digitally outputting a signal as specified in the IEC60958 standard, or the like, for reproducing media other than CDs (compact discs).

### BACKGROUND ART

Today, IEC60958 and IEC61937 are the mainstream standards for audio data streaming. FIG. 5 shows a data structure of a subframe as defined in the IEC60958 standard. In the IEC60958 standard, a user data area (a user bit denoted as “U” in FIG. 5) is provided so that the user can add information other than audio data. This similarly applies to the IEC61937 standard.

On the other hand, CDs, which are commonly used as recording media for audio data, carry a subcode (Q data) as auxiliary information in addition to audio data. FIG. 6 shows a data structure of the Q data. For example, the Q data is used as data indicating audio track boundaries (e.g., the track number or the index) as shown in FIG. 6. This similarly applies to MDs (minidiscs).

When digitally outputting audio data recorded on a CD, the Q data is superimposed on an IEC60958 digital output signal, so that a device receiving the digital output signal can identify audio track boundaries, i.e., boundaries between tracks. However, recording media other than CDs, e.g., DVDs (digital versatile discs), do not carry Q data. Therefore, as shown in the flow chart of FIG. 7, a conventional digital audio device for outputting an IEC60958 digital output signal determines the type of the medium being reproduced (step S11). The device performs an operation of superimposing the Q data on the user bit of the IEC60958 subframe (step S12) if the medium is a CD, and skips step S12 otherwise.

Thus, when digitally outputting audio data recorded on a medium other than a CD, the conventional digital audio device cannot output the useful Q data in the user bit. Therefore, the device receiving the audio data cannot identify audio track boundaries.

Similar problems arise when outputting analog audio data. Since the Q data cannot be superimposed on an analog audio signal, a device receiving an analog audio signal cannot identify audio track boundaries. A technique for solving this problem is to output a digital audio interface signal separately from an analog audio signal, and use the digital audio interface signal to add a start ID indicating a track start position to audio data obtained through A/D conversion of the analog audio signal (see, for example, Patent Document 1).

Patent Document 1: Japanese Laid-Open Patent Publication No. 7-302461

### DISCLOSURE OF THE INVENTION

Problems to be Solved by the Invention

As described above, since the Q data is not recorded on media other than CDs and MDs, the useful Q data cannot be included in the digital output signal of audio data with a conventional digital audio device. Therefore, when continuously outputting a plurality of audio tracks, the device receiving the audio data cannot identify the audio track boundaries, resulting in all the audio data being recorded as one track.

Although the method of adding a start ID described above makes it possible to identify audio track boundaries, the method does not conform to standards such as IEC60958 and IEC61937. In view of versatility, it is preferred to employ an interface that is compliant with a predetermined standard.

In view of the above, an object of the present invention is to provide a digital audio device for reproducing audio data from a recording medium such as a DVD and outputting a digital signal in compliance with a predetermined standard, wherein the digital audio device is capable of outputting audio data with useful Q data being superimposed thereon. Another object of the present invention is to provide such an audio data output method.

Means for Solving the Problems

In order to solve the problems set forth above, the present invention provides a digital audio device for outputting information recorded on a recording medium as audio data in compliance with a predetermined standard, including: a track boundary detection section for detecting an audio track boundary based on information recorded on the recording medium; a track boundary data production section for producing track boundary data indicating the audio track boundary detected by the track boundary detection section; and an auxiliary information production section for producing auxiliary information by adding a control code as specified in the predetermined standard to the track boundary data produced by the track boundary data production section, wherein audio data obtained from the recording medium is output with the auxiliary information produced by the auxiliary information production section being superimposed thereon.

With this device, even if a recording medium does not contain auxiliary information indicating an audio track boundary in compliance with a predetermined standard associated with an output signal from the digital audio device, the track boundary detection section detects the audio track boundary based on information recorded on the recording medium, the track boundary data production section produces track boundary data, and the auxiliary information production section produces the auxiliary information in compliance with the predetermined standard. Then, the auxiliary information is superimposed on the reproduced audio data, and audio data including the auxiliary information is output.

Preferably, the digital audio device includes an audio data reproduction section including the track boundary data production section and the auxiliary information production section for reproducing, from information recorded on the recording medium, audio data in compliance with the predetermined standard. The track boundary detection section outputs a predetermined signal when the audio track boundary is detected, and when the predetermined signal is received from the track boundary detection section, the audio data reproduction section produces the auxiliary information and superimposes the auxiliary information on the reproduced audio data.

Preferably, the digital audio device includes an audio data reproduction section including the auxiliary information production section for reproducing, from information recorded on the recording medium, audio data in compliance with the predetermined standard. When the track boundary data produced by the track boundary data production section is received, the audio data reproduction section produces the auxiliary information and superimposes the auxiliary information on the reproduced audio data.

Preferably, the digital audio device includes an audio data reproduction section for reproducing, from information recorded on the recording medium, audio data in compliance with the predetermined standard. The audio data reproduction section receives the auxiliary information produced by the auxiliary information production section and superimposes the auxiliary information on the reproduced audio data.

The present invention also provides an audio data output method for outputting information recorded on a recording medium as audio data in compliance with a predetermined standard, including: a track boundary detection step of detecting an audio track boundary based on information recorded on the recording medium; an auxiliary information production step of producing auxiliary information in compliance with the predetermined standard indicating the audio track boundary detected in the track boundary detection step; an audio data reproduction step of reproducing, from information recorded on the recording medium, audio data in compliance with the predetermined standard; and an auxiliary information superimposition step of superimposing the auxiliary information produced in the auxiliary information production step on the audio data reproduced in the audio data reproduction step, whereby audio data having been processed in the auxiliary information superimposition step is output.

With this method, even if a recording medium does not contain auxiliary information indicating an audio track boundary in compliance with a predetermined standard associated with an output signal from the digital audio device, the auxiliary information in compliance with the predetermined standard is produced based on information recorded on the recording medium. Then, the auxiliary information is superimposed on the reproduced audio data, and audio data including the auxiliary information is output.

Effects of the Invention

As described above, according to the present invention, when audio data recorded on a recording medium such as a DVD is digitally output in compliance with the IEC60958 standard, or the like, audio data including auxiliary information indicating audio track boundaries is output. Thus, the device receiving the audio data output from the digital audio device of the present invention can identify audio track boundaries.

### BRIEF DESCRIPTION OF THE DRAWINGS

FIG. 1 is a diagram showing a configuration of a digital audio device according to a first embodiment of the present invention.

FIG. 2 is a diagram showing a configuration of a digital audio device according to a second embodiment of the present invention.

FIG. 3 is a diagram showing a configuration of a digital audio device according to a third embodiment of the present invention.

FIG. 4 is a flow chart showing an operation performed by a digital audio device of the present invention.

FIG. 5 is a diagram showing a data structure of a subframe as defined in the IEC60958 standard.

FIG. 6 shows a data structure of Q data.

FIG. 7 is a flow chart showing an operation performed by a conventional digital audio device.

### BEST MODE FOR CARRYING OUT THE INVENTION

Embodiments of the present invention will now be described with reference to the drawings. Reference numerals used in the drawings include the following.
10A, 10B, 10C Digital audio device
13A, 13B, 13C Audio data reproduction section
14 Track boundary detection section
15 Track boundary data production section
16 Auxiliary information production section

### FIRST EMBODIMENT

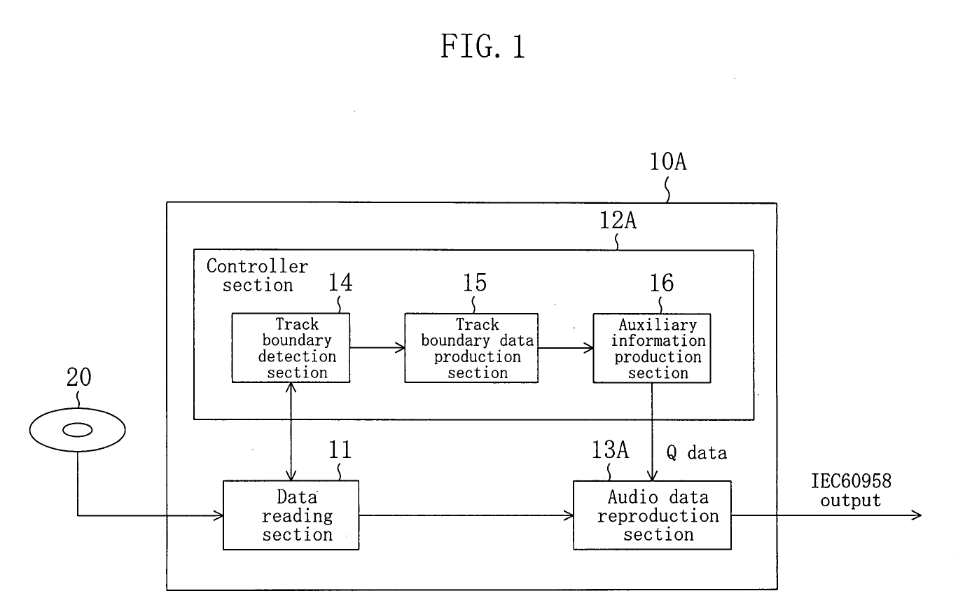

FIG. 1 shows a configuration of a digital audio device according to a first embodiment of the present invention. A digital audio device 10A of the present embodiment includes a data reading section 11 for reading out data from a recording medium 20 such as a DVD, for example, a controller section 12A for controlling the operation of the digital audio device 10A, and an audio data reproduction section 13A for reproducing audio data from the data read out from the recording medium 20, and outputs digital audio data in compliance with the IEC60958 standard.

The controller section 12A includes a track boundary detection section 14, a track boundary data production section 15 and an auxiliary information production section 16.

The track boundary detection section 14 detects audio track boundaries from data recorded on the recording medium 20 using the data reading section 11. For example, when reading out data from a DVD, it is possible to detect audio track boundaries by detecting chapter boundaries from management information recorded on the medium. The operation performed by the track boundary detection section 14 corresponds to the track boundary detection step.

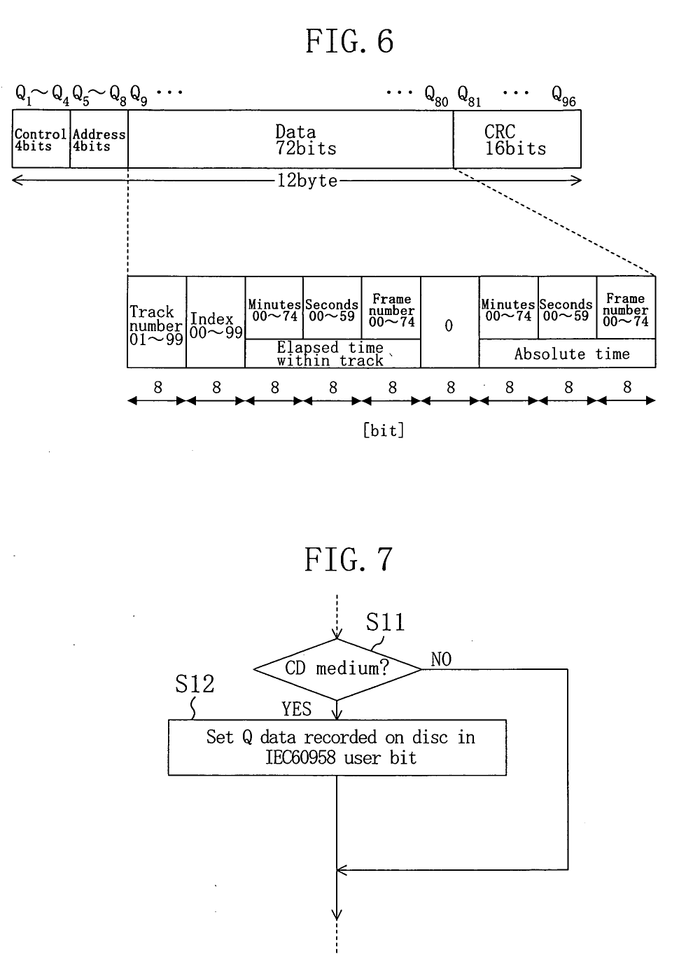

When an audio track boundary is detected by the track boundary detection section 14, the track boundary data production section 15 produces track boundary data representing the audio track boundary. Specifically, the track boundary data production section 15 produces the track number and the index information of the Q data shown in FIG. 6. In other words, the track boundary data production section 15 produces these information imitatively in response to the detection of an audio track boundary by the track boundary detection section 14. The track number can be produced by incrementing a variable each time an audio track boundary is detected.

The auxiliary information production section 16 produces auxiliary information having a predetermined data structure by adding a CRC code as a control code, and the like, to the track boundary data produced by the track boundary data production section 15. Thus, the auxiliary information production section 16 produces Q data of a complete form. The operation performed by the track boundary data production section 15 and the auxiliary information production section 16 corresponds to the auxiliary information production step.

Then, the audio data reproduction section 13A receives data read out from the recording medium 20 from the data reading section 11 and receives the Q data from the auxiliary information production section 16 to output digital audio data in compliance with the IEC60958 standard. Specifically, the audio data reproduction section 13A decodes data received from the data reading section 11 to produce a subframe having a data structure as shown in FIG. 5 (this corresponds to the audio data reproduction step), and superimposes the Q data on the user bit U in the subframe (this corresponds to the auxiliary information superimposition step) to output digital audio data.

As described above, according to the present embodiment, when audio data recorded on the recording medium 20 such as a DVD is digitally output in compliance with the IEC60958 standard, useful Q data can be included in the digital output signal. Therefore, the device connected to the digital audio device 10A can identify audio track boundaries, and record the audio data while numbering the tracks.

Moreover, the audio data reproduction section 13A is not different from that of a conventional digital audio device. Therefore, the application of the present invention does not require any hardware changes to the audio data reproduction section. Furthermore, since it is possible to use auxiliary information of various data structures without changing the hardware, the present embodiment is tolerant of changes.

### SECOND EMBODIMENT

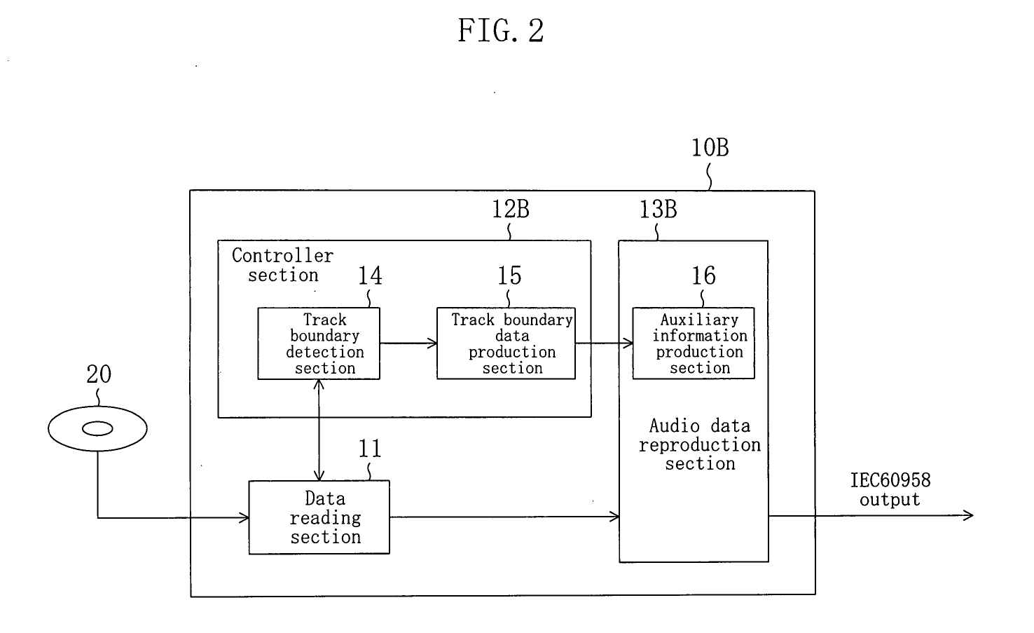

FIG. 2 shows a configuration of a digital audio device according to a second embodiment of the present invention. A digital audio device 10B of the present embodiment takes a form in which the configuration of the digital audio device 10A of the first embodiment is partially changed. The difference from the digital audio device 10A will now be described.

A controller section 12B of the present embodiment includes the track boundary detection section 14 and the track boundary data production section 15 as described above. Thus, the controller section 12B has a configuration obtained by removing the auxiliary information production section 16 from the controller section 12A of the first embodiment.

An audio data reproduction section 13B has a function of decoding data received from the data reading section 11 to reproduce audio data, as does the audio data reproduction section 13A of the first embodiment. Thus, the audio data reproduction section 13B originally has a function of producing a control code. The audio data reproduction section 13B of the present embodiment has this function in the form of the auxiliary information production section 16.

As described above, according to the present embodiment, the processing load can be distributed between the controller section 12B and the audio data reproduction section 13B. Moreover, since it is possible to use auxiliary information of various data structures without changing the hardware of the audio data reproduction section 13B, the present embodiment is tolerant of changes.

### THIRD EMBODIMENT

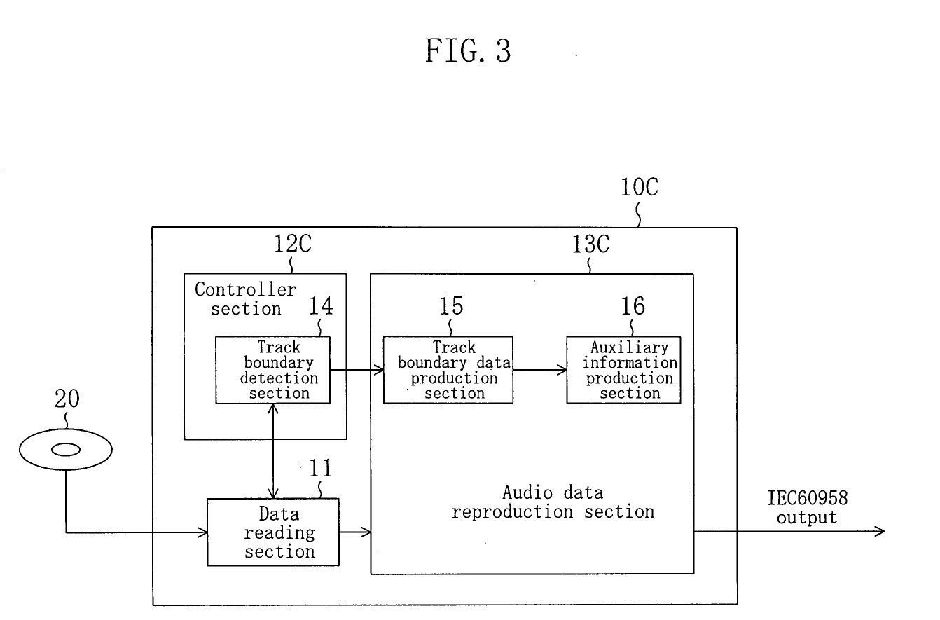

FIG. 3 shows a configuration of a digital audio device according to a third embodiment of the present invention. A digital audio device 10C of the present embodiment takes a form in which the configuration of the digital audio device 10A of the first embodiment is partially changed. The difference from the digital audio device 10A will now be described.

A controller section 12C of the present embodiment only includes the track boundary detection section 14 as described above. Thus, the controller section 12C has a configuration obtained by removing the track boundary data production section 15 and the auxiliary information production section 16 from the controller section 12A of the first embodiment. The track boundary data production section 15 and the auxiliary information production section 16 are provided in an audio data reproduction section 13C.

In the digital audio device 10C having such a configuration, the track boundary detection section 14 provided in the controller section 12C generates a pulse signal, for example, as a predetermined signal when an audio track boundary is detected. When the pulse signal is received, the audio data reproduction section 13C produces Q data and outputs audio data with the Q data being superimposed thereon.

As described above, according to the present embodiment, it is not necessary to produce Q data in the controller section 12C, and it is possible to reduce the processing load on the controller section 12C.

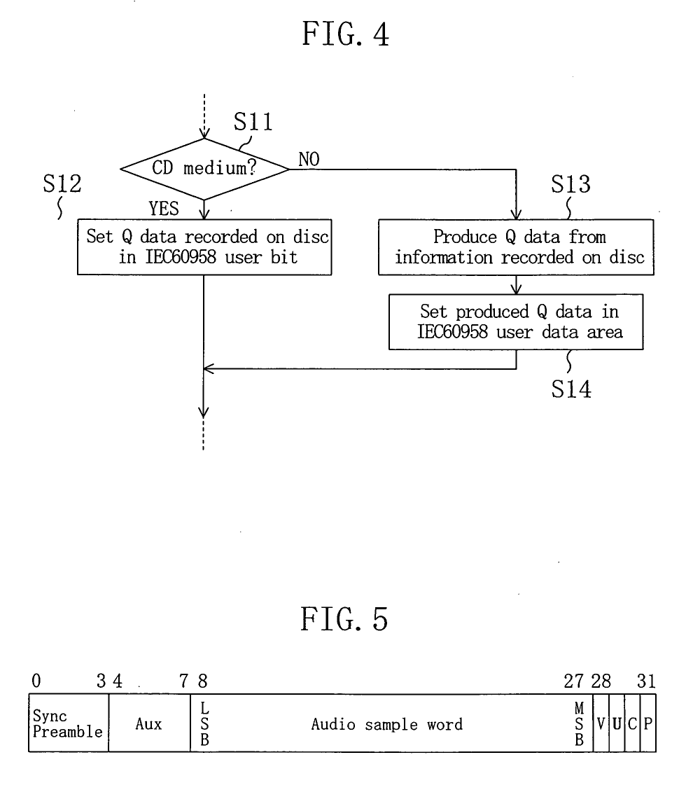

An operation performed by a digital audio device of the present invention as described above is as shown in the flow chart of FIG. 4. Specifically, the type of the medium being reproduced is determined (step S11), and Q data is superimposed on the user bit in the subframe of the IEC60958 standard (step S12) if the medium is a CD. If the medium being reproduced is a medium other than a CD, Q data as auxiliary information indicating an audio track boundary is produced (step S13), and the produced Q data is superimposed in the user data area as specified in the IEC60958 standard (step S14). Thus, audio data including useful Q data is output, irrespective of the type of a medium being reproduced.

While the present invention has been described with respect to a case where a digital signal is output in compliance with the IEC60958 standard, the present invention is not limited thereto. The present invention can also be used with the IEC61937 standard or other standards to obtain effects similar to those described above.

### INDUSTRIAL APPLICABILITY

As described above, a digital audio device of the present invention can output digital audio data including useful Q data in compliance with a predetermined standard, irrespective of the type of a medium being reproduced, and is thus useful as a DVD player capable of outputting a digital audio signal, an audio component compliant with DVD-Audio, etc.

1. A digital audio device for outputting information recorded on a recording medium as audio data in compliance with a predetermined standard, comprising:
a track boundary detection section for detecting an audio track boundary based on information recorded on the recording medium;
a track boundary data production section for producing track boundary data indicating the audio track boundary detected by the track boundary detection section; and
an auxiliary information production section for producing auxiliary information by adding a control code as specified in the predetermined standard to the track boundary data produced by the track boundary data production section,
wherein audio data obtained from the recording medium is output with the auxiliary information produced by the auxiliary information production section being superimposed thereon.

2. The digital audio device of claim 1, wherein:
the digital audio device comprises an audio data reproduction section including the track boundary data production section and the auxiliary information production section for reproducing, from information recorded on the recording medium, audio data in compliance with the predetermined standard;
the track boundary detection section outputs a predetermined signal when the audio track boundary is detected; and
when the predetermined signal is received from the track boundary detection section, the audio data reproduction section produces the auxiliary information and superimposes the auxiliary information on the reproduced audio data.

3. The digital audio device of claim 1, wherein:
the digital audio device comprises an audio data reproduction section including the auxiliary information production section for reproducing, from information recorded on the recording medium, audio data in compliance with the predetermined standard; and
when the track boundary data produced by the track boundary data production section is received, the audio data reproduction section produces the auxiliary information and superimposes the auxiliary information on the reproduced audio data.

4. The digital audio device of claim 1, wherein:
the digital audio device comprises an audio data reproduction section for reproducing, from information recorded on the recording medium, audio data in compliance with the predetermined standard; and
the audio data reproduction section receives the auxiliary information produced by the auxiliary information production section and superimposes the auxiliary information on the reproduced audio data.

5. A digital audio device for outputting information recorded on a recording medium as audio data in compliance with a predetermined standard,
wherein the digital audio device produces, from information recorded on the recording medium, auxiliary information in compliance with the predetermined standard indicating an audio track boundary, and superimposes the auxiliary information on audio data reproduced from information recorded on the recording medium.

6. An audio data output method for outputting information recorded on a recording medium as audio data in compliance with a predetermined standard, comprising:
a track boundary detection step of detecting an audio track boundary based on information recorded on the recording medium;
an auxiliary information production step of producing auxiliary information in compliance with the predetermined standard indicating the audio track boundary detected in the track boundary detection step;
an audio data reproduction step of reproducing, from information recorded on the recording medium, audio data in compliance with the predetermined standard; and
an auxiliary information superimposition step of superimposing the auxiliary information produced in the auxiliary information production step on the audio data reproduced in the audio data reproduction step,
whereby audio data having been processed in the auxiliary information superimposition step is output.
